(19) United States
(12) Patent Application Publication
(10) Pub. No.: US 2021/0315292 A1
(43) Pub. Date: Oct. 14, 2021

(54) FULL-COVER FACE FILTER MASK

(71) Applicant: MEI SIN ELECTRONICS CO., LTD., Taichung City (TW)

(72) Inventor: Yi-Ling LAI, TAICHUNG CITY (TW)

(21) Appl. No.: 16/880,440

(22) Filed: May 21, 2020

(30) Foreign Application Priority Data
Apr. 14, 2020 (TW) 109204334

(51) Int. Cl. A41D 13/11; A62B 18/10; A62D 7/02

(52) U.S. Cl. CPC A41D 13/1138; A41D 13/1161; A41D 2300/33; A62D 7/02; A62B 18/10

(57) ABSTRACT

A full-cover face filter mask includes a mask body presenting the outline of the face of the human body and having a cavity large enough to accommodate the face of the human body and an air inlet and an air outlet in communication with the cavity, and a splice frame made of a soft material and set to the mask body along the edge of the cavity. When the mask body is placed on the face of the human body, the face of the human body is fully contained in the cavity and the splice frame closely fits around the face of the human body, so that the mask body isolates the human body face and the external environment to prohibit the external air pollutants, viruses, etc. from touching the human face, avoiding infection of the human body and preventing disease.

### BACKGROUND OF THE INVENTION

### 1. Field of the Invention

The present invention relates to filter masks and more particularly, to a full-cover face filter mask.

### 2. Description of the Related Art

Whether it is for the purpose of blocking the inhalation of pollutants such as fine suspended particles in the air into the human body, or for the purpose of preventing the transmission of viruses carried by individuals to other people through droplets, the use and wearing of masks are not only necessary habits and tools for medical staff. During periods when personal health management is required, such as during an influenza epidemic or a rampant epidemic, even healthy people will be required to wear masks in their daily lives.

However, conventional masks can only cover a part of the face, especially only the mouth and nose. External droplets, contaminants and viruses can still contact other areas of the face that are not covered, thereby reducing the filtering practicality and masking effect of the mask.

### SUMMARY OF THE INVENTION

The present invention has been accomplished under the circumstances in view. It is the main object of the present invention to provide a full-cover face filter mask, which can completely isolate the face of the human body from the external environment, so that the external air pollutants and viruses will not directly contact the human face, avoiding infection of the human body, preventing disease and increasing health.

To achieve this and other objects of the present invention, a full-cover face filter mask comprises a mask body and a splice frame. The mask body comprises a cavity, an edge surrounding the cavity, an air inlet in communication with the cavity and an air outlet in communication with the cavity. The mask body presents the outline of the face of the human body. The space of the cavity is large enough to accommodate the face of the human body. The splice frame is made of a soft material and set to the mask body along the edge around the cavity. When the mask body is placed on the face of the human body, the face of the human body is fully contained in the cavity and the splice frame closely fits around the face of the human body, so that the mask body isolates the human body face and the external environment.

Preferably, the air inlet is located on the bottom side of the mask body and the air outlet is located on the opposing top side of the mask body.

Preferably, the air inlet and the air outlet are respectively provided with a one-way valve.

Preferably, the air inlet and the air outlet are respectively provided with a filter.

Preferably, the mask body is made of a transparent plastic material.

Preferably, the splice frame is selectively made of PET film, PE material or silicon rubber.

Preferably, the mask body further comprises a connection portion for the setting of a strap or other similar fixed-use items.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a rear view of a full-cover face filter mask in accordance with the present invention.

FIG. 2 is a sectional view taken along line 2-2 of FIG. 1.

FIG. 3 is a bottom view of the full-cover face filter mask in accordance with the present invention.

### DETAILED DESCRIPTION OF THE INVENTION

The first thing to explain is that the present invention can be widely used for various personal filtering purposes, as long as it is used in a comprehensive and holistic facial filtering application, it is the scope of application of the present invention. Those skilled in the art can understand that the description language of this embodiment belongs to a high-level description that does not limit the application mode. Terms such as structure, shape, direction, or setting method include but are not limited to the description content, nor are they limiting the operation modes that can be combined.

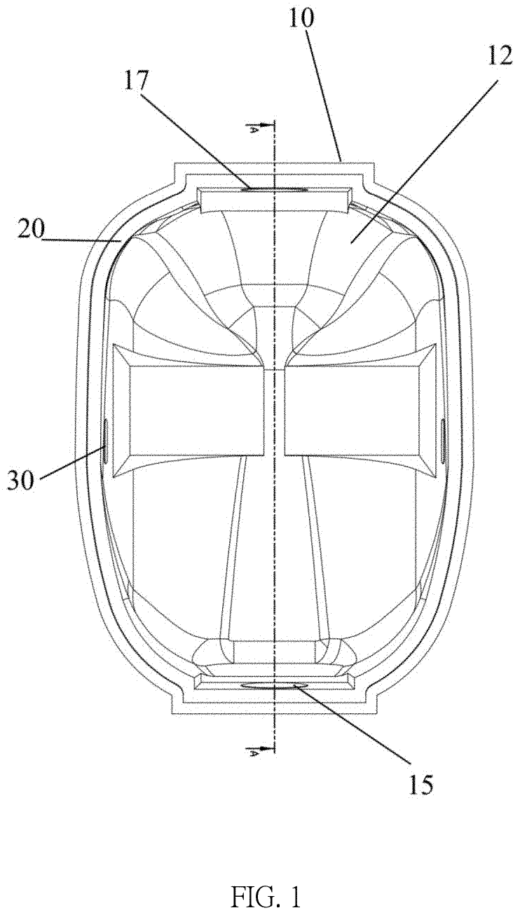

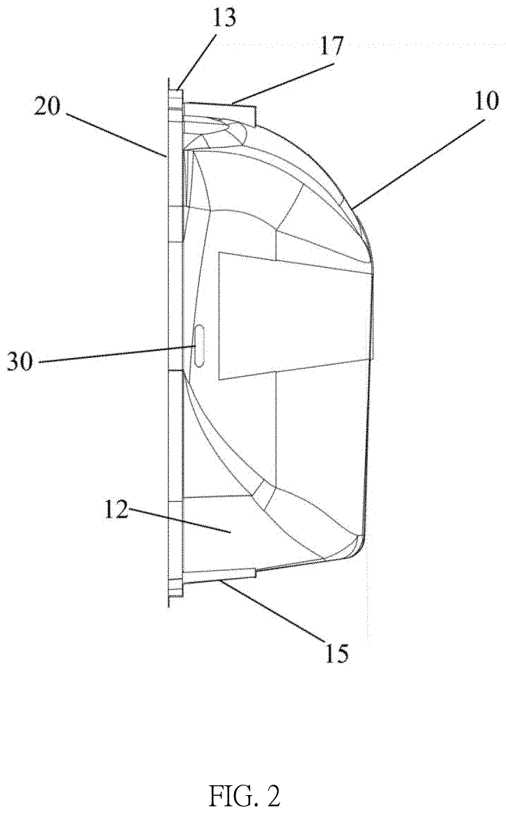

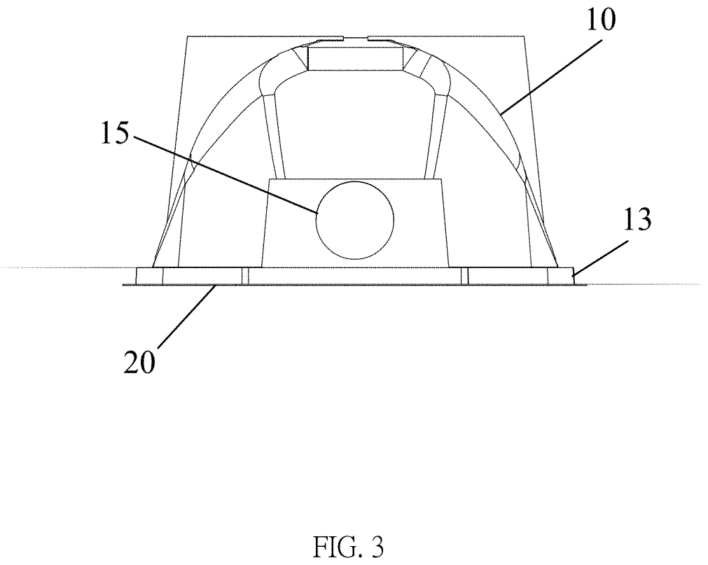

As shown in FIG. 1 to FIG. 3, a full-cover face filter mask provided by a preferred embodiment of the present invention comprises a mask body 10 and a splice frame 20. In this preferred embodiment, the mask body 10 is made of a transparent plastic material as an example, and the splice frame 20 is made of a soft material as an example.

The mask body 10 has a cavity 12 and an edge 13 surrounding the cavity 12. In this preferred embodiment, the mask body 10 presents the outline of the face of the human body, and the space of the cavity 12 is large enough to accommodate the face of the human body. The mask body 10 has an air inlet 15 and an air outlet 17, the air inlet 15 and the air outlet 17 respectively communicate with the cavity 12. Specifically, the air inlet 15 of the preferred embodiment is located at the position where the mask body 10 corresponds to the chin of the face, and the air outlet 17 is located above the forehead of the mask body 10 corresponding to the face, that is, the air inlet 15 is located at the bottom side of the mask body 10, and the air outlet 17 is located at the top side of the mask body 10.

Alternatively, the air inlet 15 and the air outlet 17 can be provided with a one-way valve, so that the gas inside the mask body 10 shows the flow direction from the air inlet 15 on the bottom side to the air outlet 17 on the top side through the cavity 12. In addition, one or both of the air inlet 15 and the air outlet 17 can be provided with a filter to keep the gas inside the cavity 12 clean.

The splice frame 20 in this preferred embodiment is made of a soft material, such as PET film, PE material or silicon rubber as an example. The splice frame 20 is set to the mask body 10 along the edge 13 of the cavity 12. When the mask body 10 is placed on the face of the human body, the face of the human body can be placed through the center of the splice frame 20 and fully contained in the cavity 12. At this time, the splice frame 20 closely fits around the face of the human body, so that the mask body 10 isolates the human body face and the external environment. Since the mask body 10 is fully covered on the face of the human body, the face of the human body is completely isolated from the external environment, so the external air pollutants, viruses, etc. will not touch the human face, avoiding infection of the human body, preventing disease, and increasing health to achieve the purpose of present invention.

The mask body 10 can be provided with a connecting portion 30 to set a strap or other similar fixed-use items, so that the mask body 10 can be fastened to the head by a strap or other similar objects, which improves the positioning and safety of the mask body 10 and facilitates the use of the present invention.

What is claimed is:

1. A full-cover face filter mask, comprising:
a mask body comprising a cavity, an edge surrounding said cavity, an air inlet in communication with said cavity and an air outlet in communication with said cavity, said mask body presenting the outline of the face of the human body, the space of said cavity being large enough to accommodate the face of the human body; and
a splice frame made of a soft material and set to said mask body along said edge around said cavity;
wherein when said mask body is placed on the face of the human body, the face of the human body is fully contained in said cavity and said splice frame closely fits around the face of the human body, so that said mask body isolates the human body face and the external environment.

2. The full-cover face filter mask as claimed in claim 1, wherein said air inlet is located on a bottom side of said mask body and said air outlet is located on an opposing top side of said mask body.

3. The full-cover face filter mask as claimed in claim 1, wherein said air inlet and said air outlet are respectively provided with a one-way valve.

4. The full-cover face filter mask as claimed in claim 1, wherein said air inlet and said air outlet are respectively provided with a filter.

5. The full-cover face filter mask as claimed in claim 1, wherein said mask body is made of a transparent plastic material.

6. The full-cover face filter mask as claimed in claim 1, wherein said splice frame is selectively made of PET film, PE material or silicon rubber.

7. The full-cover face filter mask as claimed in claim 1, wherein said mask body further comprises a connection portion for the setting of a strap or other similar fixed-use items.
